(19) United States
(12) Patent Application Publication
(10) Pub. No.: US 2023/0233285 A1
(43) Pub. Date: Jul. 27, 2023

(54) Dental Cartridge And Method For Producing A Dental Cartridge

(71) Applicant: Ivoclar Vivadent AG, Schaan (LI)

(72) Inventor: Markus Lichtensteiger, Montlingen (CH)

(21) Appl. No.: 18/159,183

(22) Filed: Jan. 25, 2023

(30) Foreign Application Priority Data
Jan. 26, 2022 (EP) 22153466.2

(51) Int. Cl. A61C 5/60

(52) U.S. Cl. CPC A61C 5/60; A61C 9/0026

(57) ABSTRACT

A dental cartridge, in particular for insertion into an injector, is configured with a cylinder body with a gripping shoulder at a first end face and with a cylinder chamber into which dental material can be filled, with a dispensing nozzle which is arranged on a second end face of the cylinder body opposite the gripping shoulder, wherein the cylinder body and the dispensing nozzle are connected via a joint. The joint is formed with a joint head in the form of a ball as part of the dispensing nozzle and with a complementary joint socket as part of the cylinder body at the second end face. The dispensing nozzle is swiveled in relation to the cylinder body in a swivel range about three axes x-y-z.

### CROSS-REFERENCE TO RELATED APPLICATIONS

This application claims priority to European patent application No. 22153466.2 filed on Jan. 26, 2022, which disclosure is incorporated herein by reference in its entirety.

### TECHNICAL FIELD

The invention relates to a dental cartridge and a method for producing a dental cartridge.

### BACKGROUND

It is known to fill a special dental material into a dental cartridge in order to use the dental material later in a dental treatment. For this purpose, the dental cartridge is inserted into an applicator, also called an injector. By means of a pistol grip and a lifting mechanism, the dental material is pressed out of a cylinder chamber in the dental cartridge through a dispensing nozzle with the help of a cylinder piston. The dental material is then used to fill cavities in molars or other teeth. Depending on the specification, the dental material can optionally be cured in an accelerated way, for example by means of UV light.

A typical dental cartridge has a cylindrical body with a dispensing nozzle protruding at an angle of, for example, 45°. The cylinder body and the dispensing nozzle are manufactured in one piece. The cylinder body is closed at a first end face with a first closure cap. The dispensing nozzle is formed at the opposite second end face of the cylinder body. A second closure cap is attached to the tip of the dispensing nozzle, which prevents the dental material from escaping during storage. The closure cap is removed for application.

There is also a dental cartridge, in particular for insertion into an injector, with a cylinder body with a gripping shoulder at a first end face, with a cylinder chamber into which dental material can be filled, and with a dispensing nozzle which is arranged at a second end face of the cylinder body opposite the gripping shoulder, the cylinder body and the dispensing nozzle being connected via a joint. The gripping shoulder is used for fastening in the injector for applying a counter pressure when the dental material is pressed out of the cylinder chamber.

DE 10 2020 109 432 A1 describes a dental cartridge with a cylinder body in which dental material can be accommodated. A dispensing nozzle is arranged on the cylinder body so that it can move in an articulated manner. The dispensing nozzle has a joint socket which engages over a joint head of the cylinder head. The dispensing nozzle and the cylinder body are manufactured by assembly injection molding.

CH 710 763 B1 describes a syringe for applying a dental mass with a cylindrical container part and with an ejection nozzle. The ejection nozzle can be swiveled relative to the container part.

US 2,717,726 is directed to a two-part valve and spout structure and is hereby incorporated by reference in its entirety.

EP 0 157 121 B and corresponding US 4,674,661, which U.S. patent is hereby incorporated by reference in its entirety, describe a container for mixing and dispensing dental masses with a chamber and with a dispensing nozzle. The dispensing nozzle is pivotably mounted in a main part. The dispensing nozzle comprises a rotatable bearing body with which the front end of the chamber can be closed.

### SUMMARY

By contrast, the invention is based on the task of providing a dental cartridge and a method for producing a dental cartridge, so that a dental cartridge can be produced compactly and efficiently.

According to the invention, it is provided that a joint is formed with a joint head in the form of a ball as part of the dispensing nozzle and with a joint socket complementary to the joint head as part of the cylinder body at a second end face and opposite a gripping shoulder. The dispensing nozzle can be pivoted, and in particular also rotated, relative to the cylinder body in a three-dimensional swivel range.

Such a dental cartridge offers several advantages. The dispensing nozzle is compactly and securely mounted in the cylinder body, even with high pressing forces that act on the dispensing nozzle when the dental material is pressed out. This means that the dispensing nozzle cannot be detached from the cylinder body by moving away from the joint. A joint that can be swiveled around all axes in the three-dimensional Cartesian coordinate system enables better access to cavities in the application process during use, so that the dental material can be introduced more safely at the desired location. This improves the ergonomics of the application process for the user and the patient. The dispensing nozzle has three rotational degrees of freedom and no translational degrees of freedom. The dispensing nozzle can be rotated and swiveled around the three axes x-y-z. The dispensing nozzle has a spout. The spout can be gripped, and by pivoting the spout, the joint ball of the dispensing nozzle can be pivoted in the joint socket of the cylinder body.

In an advantageous embodiment of the invention, the dispensing nozzle or at least its spout is made of a material that is softer than the cylinder body. It is then possible to bend the nozzle in such a way that it assumes an optimized dispensing position – e.g. for filling distal cavities – that goes beyond its pivotability.

Advantageously, the dispensing nozzle can be swiveled with its joint head in the joint socket of the cylinder body in such a way that a channel in the joint head either rests against the joint socket or is open towards the cylinder chamber. In the first position, a dispensing path of the dental material from the cylinder chamber is closed and in the second position it is open.

A swivel axis Z, about which the joint head can be swiveled in the joint socket, extends transversely to the axis of the cylinder chamber. A swivel angle of the joint head is at least about 45°, preferably up to about 135°. The channel through the swivel head is part of the dispensing path for the dental material. In the second position it is closed. According to the invention, a closure cap which can be placed on the tip of the dispensing nozzle can be dispensed with. This saves components, manufacturing steps and material. The joint and the dispensing nozzle thus have a dual function. On the one hand, the dispensing nozzle, which is specially designed according to the invention, forms an end closure of the cylinder chamber, which prevents the dental material from escaping and also enables longer storage. On the other hand, the dispensing nozzle can be ergonomically swiveled around two axes in a large, three-dimensionally extending swivel range and rotated around a further axis by up to 360°, so that any position perpendicular to the cylinder chamber can be reached by the dispensing nozzle.

The joint is designed as a ball joint. The joint ball with the dispensing nozzle attached to it can be swiveled in all spatial directions, i.e. three-dimensionally, as is usual with a ball joint. The joint socket extends around the joint ball in such a way that the latter is held securely in the joint socket on the one hand but can be swiveled as far as possible on the other. The wrap-around angle, i.e. the angle that indicates how far the joint socket extends around the joint head, is more than 180 degrees, e.g. 200 degrees or 220 degrees, or any angle between 185 degrees and 270 degrees.

The joint socket runs out, as it were towards the front, in a collar which forms a swivel stop for the dispensing nozzle projecting from the joint ball.

This results in a free three-dimensional swivel range -depending on the diameter of the dispensing nozzle at its attachment to the joint ball. This extends, for example, along an angle of 45 degrees in relation to the axis of the cylinder body but can also be selected to be smaller or larger as desired, e.g. between 20 degrees and 80 degrees.

In this free swivel range, the dental cartridge is open. The channel passing through the joint ball and the dispensing nozzle is therefore not closed at its rear end by the joint socket but is open to the cylinder chamber.

When dental material is inserted in the dental cartridge, it can be pressed out in a known manner when pressure is applied to a piston entering the cylinder body and applied to the desired location. The dentist benefits from the free three-dimensional swiveling of the dispensing nozzle, as this means that he does not first have to turn the entire dental cartridge including the dispensing device but can quickly align the dispensing nozzle to the desired application site.

According to the invention, however, the dental cartridge can also be closed, if necessary, purely by swiveling beyond the free swivel range.

As soon as the swiveling is continued beyond the free swiveling range, the rear opening of the channel comes into contact with the joint socket. If the swiveling continues, it will finally be closed by the joint socket. This is the closed position of the dental cartridge.

In order to make this possible, the cylinder body has a recess in the joint socket in a preferred design. This is open towards the front, i.e. in the direction away from the gripping shoulder. It is able to receive the dispensing nozzle at its projection to the joint ball. Preferably, the dimensions of the projection and the recess are chosen in such a way that the projection can be locked in the recess.

According to an advantageous embodiment, the dispensing nozzle of the dental cartridge is formed on the joint head with a neck ring which protrudes from the joint head and can be latched laterally on the joint socket in a complementary recess which is part-circular, in particular as seen in plan view, with a circular axis perpendicular to the cylinder axis of the cylinder chamber.

When the dispensing nozzle, in particular with its neck ring, is in the recess, it extends transversely to the axis of the cylinder body.

Furthermore, for the latching function of the dispensing nozzle, a geometric chord of the recess which forms a passage opening for the projection or neck ring to the free swivel range of the joint ball and the dispensing nozzle in the joint socket is preferably slightly smaller than the diameter of the projection or neck ring, i.e. in particular as in the case of a press fit.

Furthermore, the dispensing nozzle can be rotated through 360°. In a preferred embodiment, the dispensing nozzle is offset so that the dentist is able to set the application point as desired, even by turning the dispensing nozzle.

Further preferably, the dispensing nozzle of the dental cartridge comprises a spout with a spout axis. A channel, in particular a conically tapering channel, with a channel axis is formed in the joint head, whereby the spout axis preferably forms an angle of approximately 45° to the channel axis to provide the cranking. However, this cranking angle can also be selected as larger or smaller as desired, e.g., between 0 degrees (no cranking) and 80 degrees. This allows the spout axis to be swiveled by 90° from a straight position parallel to the cylinder axis of the cylinder chamber to an inclined position, if necessary even perpendicular to the cylinder axis. This makes it easy to also reach distally located cavities on molars. The dispensing nozzle can be swiveled and rotated up to 360° three-dimensionally in a ball-and-socket joint, so that any angle can be reached, even if the position of the dispensing device of the dental cartridge remains constant during application.

Preferably, the dispensing nozzle is designed to taper in its outer contour.

According to a further preferred embodiment, the diameter of the joint head is larger than the diameter of the cylinder chamber and the joint socket of the dental cartridge is formed as a bead at the end opposite the gripping shoulder with respect to the rest of the cylinder body. This allows the cylinder body to be manufactured in a material-saving manner. The closable joint provides a good seal between the cylinder chamber and the dispensing nozzle. A larger diameter of the joint head than that of the cylinder chamber improves the compact bearing.

In order to simplify and improve the manufacturing process of the dental cartridge and to reduce the number of parts, the cylinder body and the dispensing nozzle are manufactured by means of assembly injection molding, in particular by means of two-component assembly injection molding. Further assembly processes are no longer necessary.

According to a further embodiment, the material of the cylinder body differs from the material of the dispensing nozzle, whereby a material pairing is used so that no, preferably only moderate, adhesion occurs between the materials in the joint. Different materials have the advantage that they can be separated more easily in the manufacturing process, in the injection molding process, so that a joint can be formed (more) easily. The cylinder body can be made of a harder plastic than the dispensing nozzle. An elastic dispensing nozzle has the advantage that manual contact pressures are compensated for when filling the cavities. A lack of adhesion between the two materials has the advantage that the joint can move freely. A moderate adhesion has the advantage that the set position of the joint is maintained up to a certain pressure limit.

Any suitable material pairs can be used for assembly injection molding. These include:
polyamide 66/polyoxymethylene (PA66/POM)
polyphenylene sulfide/polyoxymethylene (PPS/POM)
polyphenylene sulfide/polyamide 6 (PPS/PA6)
polyetheretherketone/polyphenylene sulfide (PEEK/PPS)

However, any other suitable material pairings are also possible, such as:
thermoplastic elastomers/acrylonitrile butadiene styrene (TPE/ABS)
modified polyamide 6/ polyethylene (PA6 mod./PE)
modified polyamide 6/ polyoxymethylene (PA6 mod./POM)
polyethylene/poly(methyl methacrylate) (PE/PMMA)
polycarbonates/polystyrene (PC/PS)
polypropylene/ poly(methyl methacrylate) (PP/PMMA)
polypropylene/ polyoxymethylene (PP/POM)
polypropylene/polystyrene (PP/PS).

If a more elastic material is selected for the joint ball with the dispensing nozzle, the following material combinations are possible, for example:
polyamide 6/ ethylene propylene diene monomer (PA6/EPDM)
polyamide 6/natural rubber (PA6/NR)
polyamide 6/styrene-butadiene rubber (PA6/SBR)
polybutylene terephthalate/natural rubber (PBT/NR)
polybutylene terephthalate/styrene-butadiene rubber (PBT/SBR).

The coefficient of friction can also be influenced as desired by a suitable adjustment of the temperature difference during injection molding of the materials.

A dental cartridge according to the invention can in particular be inserted into an injector or a dispensing device. Two components, a cylinder body with the joint socket and a dispensing nozzle with the joint ball, are connected via a ball joint. According to the invention, both components are manufactured in a single operation using the assembly injection molding process, in particular in a single injection mold.

With slides in the injection mold, the dispensing nozzle is injected first, as required, and in the second step the cylinder body with the joint socket is injected onto the dispensing nozzle. It goes without saying that the cylinder body can also be injected first and then the dispensing nozzle the other way round. In order to create a uniform surface of the joint head, it is preferable to first create the dispensing nozzle in the injection mold. Advantageously, further assembly steps are saved.

It is preferable that the dental cartridge includes a cylinder body with a gripping shoulder at one end face and a cylinder chamber configured for filling with dental material, a dispensing nozzle which is arranged at a second end face of the cylinder body opposite the gripping shoulder, where the cylinder body and the dispensing nozzle are connected via a joint, wherein the joint is formed with a joint head in the form of a ball as an integral part of the dispensing nozzle and with a joint socket complementary to the joint head as an integral part of the cylinder body at the end face opposite the gripping shoulder, wherein the dispensing nozzle can be swiveled relative to the cylinder body in a three-dimensional swivel range, and wherein the diameter of the joint head is larger than the diameter of the cylinder chamber.

It is preferable that the dental cartridge is insertable into an injector.

It is preferable that the joint is designed as a mechanism for closing and opening a dispensing path of dental material from the cylinder chamber with a swivel axis and with a swivel angle of at least approximately 110°, preferably at least 135°.

It is preferable that a recess which extends outside the cylinder axis of the cylinder chamber is formed on the joint socket of the cylinder body and wherein the dispensing nozzle is configured for pivoting into the recess by a projection adjoining the joint ball and is configured to be brought into a closed position of the dental cartridge.

It is preferable that the recess is substantially U-shaped and is open towards the front and the second end face opposite the gripping shoulder.

It is preferable that the dispensing nozzle is designed for locking to the recess, and wherein a geometric chord of the recess, which forms a passage opening for the neck ring to the swivel range within the joint socket, is designed smaller or less than 10% smaller, than the diameter of the projection.

It is preferable that the dispensing nozzle can be swiveled in all directions in the swivel range in an open state of the dental cartridge, wherein a swivel angle of the swivel range, viewed from the cylinder axis, is at least 45°.

It is preferable that a channel for the joint head extends through the joint head, of which the end facing the cylinder chamber can be closed by swiveling the dispensing nozzle.

It is preferable that the dispensing nozzle comprises a spout with a spout axis and a channel with a channel axis is formed in the joint head, where the spout axis is formed at an angle of between 0° and 70°, preferably between 30° and 60°, to the channel axis, where the channel is formed so as to taper into the neck ring of the dispensing nozzle.

It is preferable that the joint socket is formed as a bead projecting relative to the rest of the cylinder body at the second end face opposite the gripping shoulder.

It is preferable that the material used for the cylinder body differs from the material used for the dispensing nozzle, wherein a material pairing of the cylinder body material and the dispensing nozzle material is such that a coefficient of sliding friction µslide between the materials of less than 0.8, in particular of less than 0.6, is used in the joint.

It is preferable that the materials of the cylinder body and the dispensing nozzle are selected from material pairs suitable for material injection molding and have different coefficients of thermal expansion, and in particular are made of PA66/POM, PPS/POM, PPS/PA6 or PEEK/PPS.

It is preferable that the cylinder body and the dispensing nozzle are produced by means of assembly injection molding, in particular by means of two-component assembly injection molding.

It is preferable that a method for producing a dental cartridge having a cylinder body and a dispensing nozzle which are connected via a joint, includes producing the cylinder body and the dispensing nozzle by assembly injection molding, producing the joint with a joint head in the form of a ball as part of the dispensing nozzle and with a joint socket complementary to the joint head as part of the cylinder body, and producing the dispensing nozzle configured to be mounted so as to be pivotable in three dimensions relative to the cylinder body.

### BRIEF DESCRIPTION OF THE DRAWINGS

Further advantages, details and features result from the following description of several embodiments of the invention with reference to the drawings, in which:

FIG. 1 shows a dental cartridge in perspective cross-section with closed dispensing nozzle;

FIG. 2 shows a complete dental cartridge in perspective according to FIG. 1;

FIG. 3 shows a dental cartridge in perspective cross-section with closed dispensing nozzle;

FIG. 4 shows a complete dental cartridge in perspective according to FIG. 3,

FIG. 5 shows a dental cartridge in perspective cross-section with a spout extending substantially in the direction of the cylinder body;

FIG. 6 shows a complete dental cartridge in perspective according to FIG. 5;

FIG. 7 shows a dental cartridge in perspective cross-section with the spout in the direction perpendicular to the cylinder axis of the cylinder body;

FIG. 8 shows a complete dental cartridge in perspective according to FIG. 7;

FIG. 9 shows a dental cartridge in perspective cross-section with closed dispensing nozzle with an insert in a circumferential section of the cylinder body; and

FIG. 10 shows a complete dental cartridge in perspective according to FIG. 9.

### DETAILED DESCRIPTION

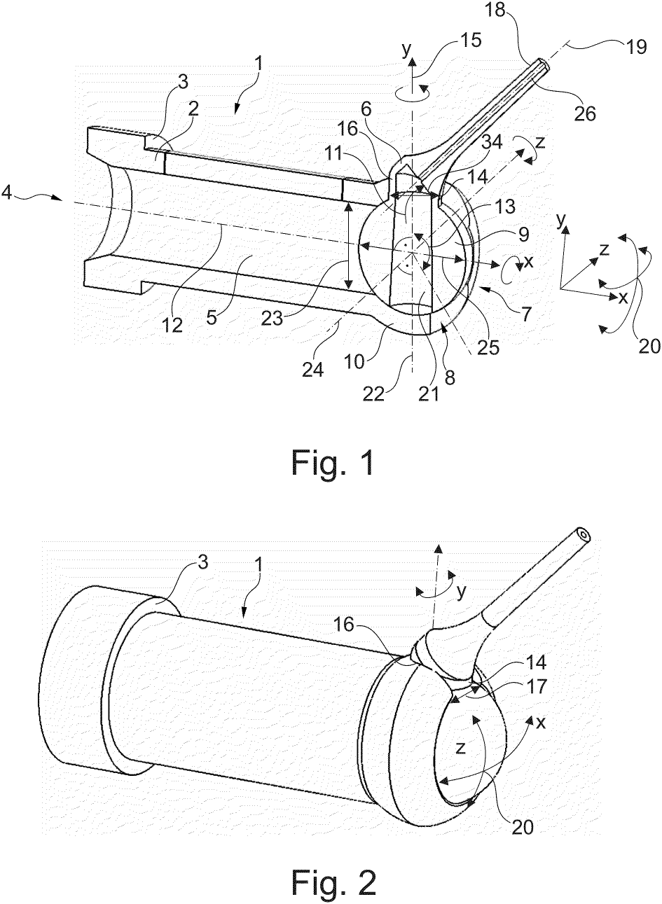

FIG. 1 shows a dental cartridge 1 for insertion into an injector not shown. The dental cartridge 1 has a cylinder body 2 and a dispensing nozzle 6. The cylinder body 2 has a gripping shoulder 3 at a first end face 4 and a cylinder chamber 5 into which dental material can be filled. The dispensing nozzle 6 is arranged at a second end face 7 of the cylinder body 2, which is opposite the gripping shoulder 3. A dental material for filling cavities during dental treatment is stored in the cylinder chamber 5. The cylinder chamber 5 is closed at both end faces, at the end face 4 by a foil as packaging material or a piston of the injector, which is not shown, and at the second end face 7 by the ball joint, which is special according to the invention, in its closed position.

The cylinder body 2 and the dispensing nozzle 6 are connected by a joint 8. The joint 8 is formed with a joint head 9 in the form of a ball as part of the dispensing nozzle 6 and with a complementary joint socket 10 as part of the cylinder body 2 at the second end face 7, opposite the gripping shoulder 3. The dispensing nozzle 6 can be pivoted about the two axes x and z and rotated about the y-axis in a swivel range 20 relative to the cylinder body 2.

FIG. 1 shows the dental cartridge 1 in a cross-sectional view with a closed cylinder chamber 5 at the second end face 7. The dental material is filled into cylinder chamber 5 from the first end face 4. After the filling process, the first end face 4 is also completely closed until use, e.g. with a foil not shown.

As soon as the dental cartridge 1 is inserted into an injector, a piston of the injector is inserted into the cylinder chamber 5 from the end face 4 in the application process. The dental material is pressed out of the cylinder chamber 5 in the direction of the second end face 7 into the dispensing nozzle 6.

The dispensing nozzle 6 is formed on the joint head 9 with a projecting elongated neck ring 14, which is designed to lock in a complementary circular recess 16 with a circular axis 15 perpendicular to the cylinder axis 12 of the cylinder chamber 2 and perpendicular to the swivel axis 24 on the circumference of the joint socket 10. The circular axis 15 coincides with the Y pivot axis 22 of the joint 8, i.e., is congruent to it.

In order to realize the locking function, a geometric chord 17 of the recess 16, which forms a passage opening for the neck ring 14 to the swivel range 20 within the joint socket 10, is slightly smaller than the diameter 34 of the neck ring 14.

The joint 8 of the dental cartridge 1 has a dual function. It serves to close and open the dispensing path 11 for the dental material from the cylinder chamber 5. For opening, the dispensing nozzle 6 is swiveled out of the recess 16 and then extends further forwards, i.e. away from the gripping shoulder. A swivel axis 24 of the joint socket 10 is formed obliquely to or even perpendicular to the cylinder axis 12 and perpendicular to a circular axis 15 and congruent with the Z-axis of the dispensing nozzle 6. In the open position, the dispensing nozzle 6 can be swiveled freely, with a swivel angle 13 of at least 45° to approximately 135°, relative to the cylinder axis 12.

A free swivel range 20 of the dental cartridge comprises swivel angles for the dispensing nozzle 6 about its three axes x-y-z. The free swivel range 20 possible for the application is at least 45° in both directions, i.e., at least 90° in total, around the x-y-axis from the cylinder axis 12. The dispensing nozzle can be rotated through 360° around the Z-axis.

The dispensing nozzle 6 comprises a spout 18 with a spout axis 19. The spout 18 has a spout channel 26 with the same inner diameter over the entire length of the spout. Thus, a dosage of the dental material can be precisely controlled manually. A channel 21, in particular, a conically tapering channel, with a channel axis 22 is formed in the joint head 9, which opens into the beveled spout channel 26. In the closed position of the dispensing nozzle 6 shown in FIG. 1, the channel axis 22 coincides with the Y-axis for rotation through 360° and the circular axis 15.

The spout axis 19 preferably forms an angle of approx. 45° to the channel axis 22. The channel 21 is formed into the neck ring 14 of the dispensing nozzle 6. The spout 18 forms a tapering funnel shape from the neck ring 14, at least in the outer contour.

The diameter 25 of the joint head 9 is larger than the diameter 23 of the cylinder chamber 5. Thus the joint socket 10 forms a bead at the second end adjacent to the second end face 7 with respect to the rest of the cylinder body 2. The joint head 9 is thus mounted in a stable and secure manner. The channel 21 of the dispensing nozzle 6 in the joint head 9 is thus as large as possible, which leads to a reduced force during ejection.

The cylinder body 2 and the dispensing nozzle 6 are preferably produced in an integrated injection mold not shown, preferably by means of a two-component assembly injection molding. A suitable material pairing is selected so that moderate or no adhesion occurs between the cylinder body 2 and the dispensing nozzle 6. Possible material pairings are known to the skilled person, for example, from the prior art mentioned at the beginning.

FIG. 2 shows the body of the dental cartridge 1 from FIG. 1 in perspective view, but in the closed position. The three degrees of freedom of the swivel range 20, the rotation about the y-axis and the swivel about the x-z-axes, as well as the locking of the neck 14 in the recess 16 with the aid of the chord 17 as an interference fit 16 are shown.

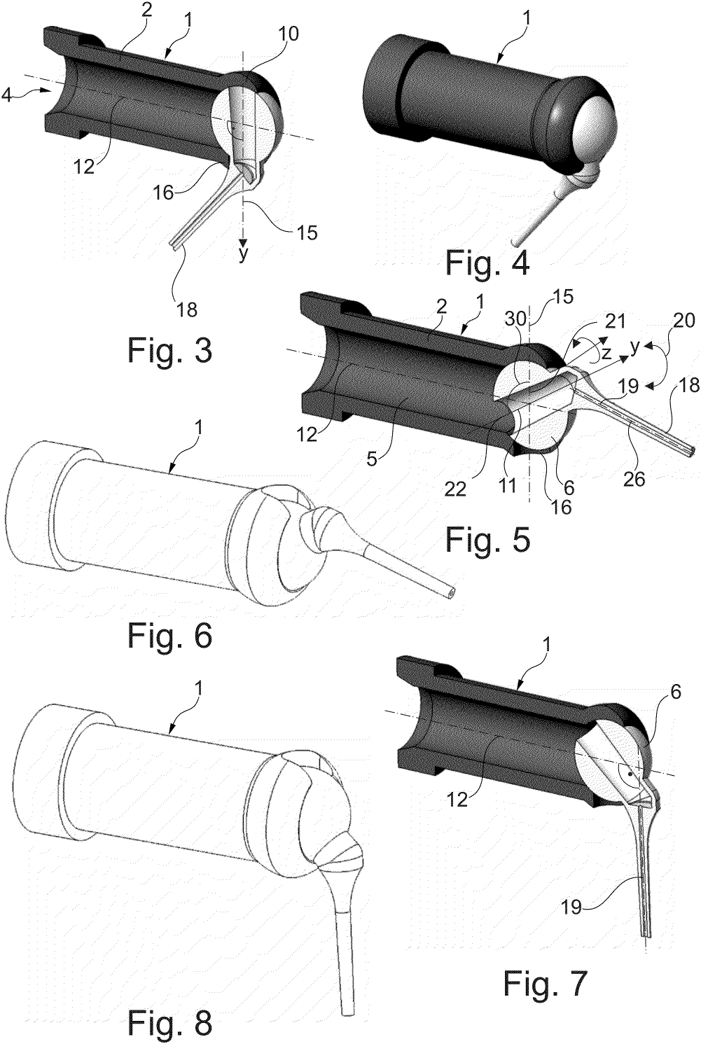

FIG. 3 shows a perspective cross-sectional view similar to FIG. 1, with the difference that the recess 16 in the joint socket 10 is not rotated upwards with the y-axis, but around the cylinder axis 12 by 180° and thus directed downwards. The spout 18 is shown rotated by 180° about the Y-axis in relation to the first end face 4 as shown in FIG. 1. This is, for example, a storage state in which the length of the dental cartridge 1 is minimized. The height and the width/depth of the dental cartridge 1 are identical in both storage states, i.e. according to FIG. 1 and FIG. 3. In FIG. 3, the Y-axis of the dispensing nozzle is congruent with the circular axis 15 of the recess 16, which are both at right angles to the cylinder axis 12.

FIG. 4 shows the dental cartridge 1 according to FIG. 3 as a complete body.

FIG. 5 shows the dental cartridge 1 in longitudinal cross-section, whereby the dispensing nozzle 6 is swiveled upwards by an angle 30 of more than 90°, i.e. for example approx. 120°, compared to the view in FIG. 3. The dispensing nozzle 6 can be swiveled in the swivel range 20 despite the recess 16 to such an extent that the dispensing path 11 for applying the dental material from the cylinder chamber 5 through the dispensing channel 21 and through the spout channel 26 of the spout 18 remains closed. The spout axis 19 is swiveled downwards by approx. 15° with respect to the cylinder axis 12. The spout 18 is thus a longitudinal extension of the cylinder body 2 in essence.

FIG. 6 shows the completely closed body of the dental cartridge 1 in the state according to FIG. 5.

FIG. 7 shows the longitudinal cross-sectional half of the dental cartridge 1 as in FIGS. 3 and 5, with the difference that, in contrast to FIG. 3, the dispensing nozzle 6 is swiveled by approx. 45°, so that the spout axis 19 is swiveled essentially perpendicular to the cylinder axis 12. Cavities can thus be reached at an angle of 90° from a horizontal position of the cylinder body 2 for filling.

FIG. 8 shows the dental cartridge 1 as a complete body in a swiveled state of the dispensing nozzle 6 according to FIG. 7.

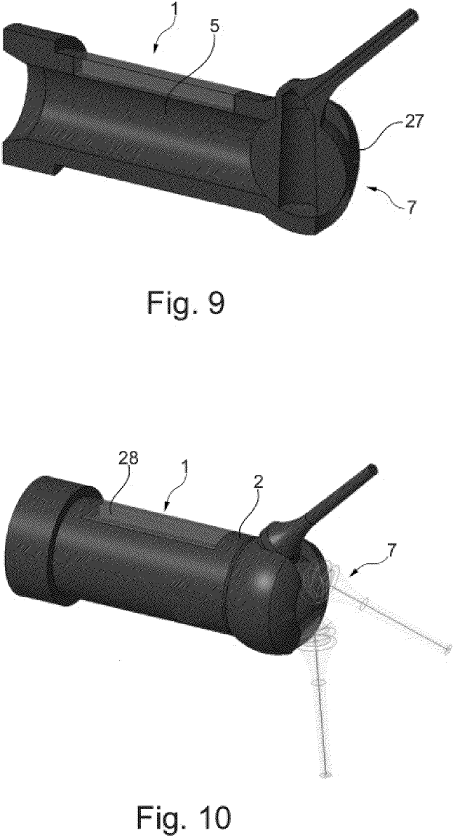

FIG. 9 essentially shows the embodiment according to FIG. 1. In an area of the cylinder body 2 shown above, a window 28 is formed which extends flush with the inside and outside of the cylinder body 2. This makes the filling state of the cylinder body 2 in the cylinder chamber 5 with dental material directly visible to the user. Furthermore, the color and at least approximately the consistency of the dental material is also visible to the user.

In an embodiment not shown, a slot extends through the joint socket on both sides parallel to the axis of the cylinder body 2. Slots increase the elasticity of the joint socket 10 so that the adhesion between the joint head 9 and the joint socket 10 is reduced.

The terms “about” and “substantially” are intended to include the degree of error or uncertainty associated with measurement of the particular quantity or shape as one of ordinary skill in the art would understand.

1. A dental cartridge (1) comprising
a cylinder body (2) with a gripping shoulder (3) at one end face (4) and a cylinder chamber (5) configured for filling with dental material,
a dispensing nozzle (6) which is arranged at a second end face (7) of the cylinder body (2) opposite the gripping shoulder (3),
where the cylinder body (2) and the dispensing nozzle (6) are connected via a joint (8),
wherein the joint (8) is formed with a joint head (9) in the form of a ball as an integral part of the dispensing nozzle (6) and with a joint socket (10) complementary to the joint head (9) as an integral part of the cylinder body (2) at the end face (7) opposite the gripping shoulder (3),
wherein the dispensing nozzle (6) can be swiveled relative to the cylinder body in a three-dimensional swivel range, and
wherein the diameter (18) of the joint head (9) is larger than the diameter (15) of the cylinder chamber (5).

2. The dental cartridge (1) according to claim 1,
wherein the cartridge is insertable into an injector.

3. The dental cartridge according to claim 1,
wherein the joint (8) is designed as a mechanism for closing and opening a dispensing path (11) of dental material from the cylinder chamber (5) with a swivel axis (12) and with a swivel angle (13) of at least approximately 110°.

4. The dental cartridge according to claim 1,
wherein a recess (16) which extends outside the cylinder axis (12) of the cylinder chamber (5) is formed on the joint socket (10) of the cylinder body, and
wherein the dispensing nozzle (6) is configured for pivoting into the recess (16) by a projection (14) adjoining the joint ball and is configured to be brought into a closed position of the dental cartridge.

5. The dental cartridge according to claim 4,
wherein the recess (16) is substantially U-shaped and is open towards the front and the second end face opposite the gripping shoulder.

6. The dental cartridge according to claim 4,
wherein the dispensing nozzle (6) is designed for locking to the recess (16), and
wherein a geometric chord of the recess (16), which forms a passage opening for the neck ring to the swivel range within the joint socket, is designed smaller than the diameter of the projection (14).

7. The dental cartridge according to claim 1,
wherein the dispensing nozzle (6) can be swiveled in all directions in the swivel range in an open state of the dental cartridge, wherein a swivel angle of the swivel range, viewed from the cylinder axis, is at least 45°.

8. The dental cartridge according to claim 1,
wherein a channel (21) for the joint head extends through the joint head (9), which end can be closed by swiveling the dispensing nozzle (6).

9. The dental cartridge according to claim 1,
wherein the dispensing nozzle comprises a spout (18) with a spout axis (19) and a channel (21) with a channel axis is formed in the joint head, where the spout axis is formed at an angle of between 0° and 70° to the channel axis, where the channel is formed so as to taper into the neck ring of the dispensing nozzle.

10. The dental cartridge according to claim 1,
wherein the joint socket (10) is formed as a bead projecting relative to the rest of the cylinder body at the second end face (7) opposite the gripping shoulder (3).

11. The dental cartridge according to claim 1,
wherein the material used for the cylinder body (2) differs from the material used for the dispensing nozzle (6),
wherein a material pairing of the cylinder body material and the dispensing nozzle material is such that a coefficient of sliding friction µslide between the materials of less than 0.8, is used in the joint.

12. The dental cartridge according to claim 11,
wherein the materials of the cylinder body and the dispensing nozzle are selected from material pairs suitable for material injection molding and have different coefficients of thermal expansion.

13. The dental cartridge according to claim 1,
wherein the cylinder body and the dispensing nozzle are produced by means of assembly injection molding.

14. A method for producing a dental cartridge of claim 1, having a cylinder body and a dispensing nozzle which are connected via a joint, comprising
producing the cylinder body and the dispensing nozzle by assembly injection molding,
producing the joint (8) with a joint head (9) in the form of a ball as part of the dispensing nozzle (6) and with a joint socket (9) complementary to the joint head as part of the cylinder body (2), and
producing the dispensing nozzle (6) configured to be mounted so as to be pivotable in three dimensions relative to the cylinder body.
